(19) United States
(12) Patent Application Publication
(10) Pub. No.: US 2010/0299277 A1
(43) Pub. Date: Nov. 25, 2010

(54) SYSTEM AND METHOD FOR CREATING AND ENHANCING MENTORING RELATIONSHIPS

(76) Inventors: Randy Emelo, Thornton, CO (US); Chris Browning, Lone Tree, CO (US); Tom McGee, Littleton, CO (US); Mark Sanner, Parker, CO (US); Rob Meidal, Littleton, CO (US); John Blayter, Castle Rock, CO (US); Micah Pritchard, Denver, CO (US); Scott Ryan, Littleton, CO (US)

Correspondence Address: SHERIDAN ROSS PC, 1560 BROADWAY, SUITE 1200, DENVER, CO, 80202, US

(21) Appl. No.: 12/783,177

(22) Filed: May 19, 2010

Related U.S. Application Data
(60) Provisional application No. 61/179,628, filed on May 19, 2009.

(51) Int. Cl. G06Q 10/00

(52) U.S. Cl. 705/319; 705/1.1

(57) ABSTRACT

The present invention provides methods, devices, and systems for enhancing the dissemination of information throughout an organization, and more particularly to developing meaningful mentoring relationships within such an organization. Tools are provided that allow mentors and learners to define their current traits as well as relationship goals and, based on those defined traits and goals, locate valuable learners/mentors.

### CROSS REFERENCE TO RELATED APPLICATIONS

This application claims the benefit of U.S. Provisional Application No. 61/179,628, filed May 19, 2009, the entire disclosure of which is hereby incorporated herein by reference.

### FIELD OF THE INVENTION

The invention relates generally to systems and methods for facilitating the transfer of knowledge and personal experience within an organization.

### BACKGROUND

Everyone can look at the progress of their life and recall advisors who have impacted their life. Advisors offer, among other things, guidance, support, and wisdom that is based on experience and knowledge. Mentoring is a process through which people facilitate the development of others by sharing known resources, expertise, values, skills, perspectives, attitudes and proficiencies. It allows learners to build skills and knowledge while attaining goals for personal and career development. Conversely, it provides the opportunity for the experienced advisors to further enhance their skill and knowledge areas by continuously reassessing and building upon those areas. Additionally, learners have a way of showing their advisors a new perspective on a seemingly old problem, possibly shedding light on a new and better solution.

In addition to those who are directly involved in its practice, mentoring also helps the community at large because it fosters an environment in which people work together and assist one another in their drive to become better skilled, more intelligent individuals. Accordingly, many types of organizations from profit to non-profit to government organizations and enterprises can benefit from mentoring and the relationships generated through mentoring.

### SUMMARY

Embodiments of the present invention provide a dynamic and intelligent mechanism for creating and fostering mentoring relationships. In accordance with at least some embodiments of the present invention, a web-based application is provided that helps organizations run intra-organizational mentoring programs. As can be appreciated, however, an enterprise-based or node-based application may be provided in addition to or in lieu of the web-based application. The system is configurable by clients. Basic features do not change, although clients can turn different features on and off based on their specific needs and leverage best practice workflows or build their own using a workflow wizard. The client's site is configured for the client, with the configuration focused on incorporating the client's organizational competency set(s), look/feel (e.g., logos, colors, graphics), and employee profile information (e.g., incorporating the organization's business unit hierarchy/structure). Thus, a provider of mentoring solutions may provide multiple different sites to each of their customers.

One aspect of the present invention is to provide an Enterprise Mentoring System that includes three different best practice workflows for individuals with learning needs to connect with and learn from experts within their organizations. These three components are: One-to-One Mentoring, Group Mentoring, and Situational Mentoring. These workflows are customizable to the organization as well.

Regardless of which process(es) users engage in, all users create a profile that includes one or more of the following information areas:
Areas of expertise—users identify the competencies where they have domain expertise upon which they can advise others. Each client's site is configured with their organizational competencies
Areas of development—general areas that the users are looking to improve upon
Demographic data—fields such as business unit, job level, job title, location
Work history data—fields such as job history, educational history, functional expertise

One-to-One Mentoring

In the one-to-one mentoring process, individuals are allowed to connect with one another for the purpose of more traditional, one-to-one mentoring relationships. Embodiments of the present invention help learners frame up their learning needs by selecting from a list of the organization's competencies, giving an indication of the competency areas they would like to focus on over the course of the relationship. They also establish knowledge and ability-based goals and propose a duration for the relationship, typically ranging from 2 to 12 months (as can be appreciated, a learner/advisor relationship can last for a greater or lesser amount of time depending upon client and user needs and can be user or client configurable). The client has the ability to enable up to four different ways for learners to become matched with advisors:
1. Self-selection—this is where the learner is provided with a list of potential advisors. The initial results are presented based on % of competencies matched. The competencies selected by the learner are compared with all available advisor profiles. For example, if a learner elects to work on 4 competencies during the relationship, advisors who have all 4 noted as areas of expertise in their profiles will show as 100% matches, those matching 3 of the 4 will show as 75% matches, and so on. After receiving the initial matches, learners can view the advisors' detailed profiles, invite advisors, or conduct more detailed/advanced searches by selecting from additional field filters (e.g., looking for advisors who work in a particular business unit, are located in a specific office, are of a particular job level). Ultimately, the learner is guided to invite an advisor into a relationship. An advisor who is invited can accept or decline an invitation from the learner. If accepted, the pair is engaged and encouraged to begin mentoring. If declined, the learner is alerted and encouraged to invite another advisor.
2. Administrator/third-party match—clients may enable this manner of matching by itself or in combination with self-directed matching. There are two main ways that this process works. First, upon framing up their relationship (i.e. selecting competencies, defining goals and duration), the learner can “submit” it to an administrator, who will use an administrative interface to make the match for the learner. The administrator can choose to invite the advisor, in which case the advisor is given the ability to accept or decline, or assign the advisor, in which case the pair is engaged upon the assignment. The second type of administrator/third-party matching is a process in which the third-party entity creates the engagement (i.e., they select the competencies and define goals) for the learner(s) who will engage in the relationship. They then use the administrative interface to identify and either invite and/or assign the learners and advisors to the relationship. For example, a manager could create an engagement for one of their reports and then assign one or more advisors to assist the individual with the learning need.
3. Advisor-Driven Search—with this feature, advisors who are motivated to connect with a learner can search relationships that have been framed up by a learner where the learner has not yet invited an advisor. If an advisor chooses to search for learners, they will follow a process that is very similar to the self-selection process for learners. Advisors will see learners whose framed relationships match well with their expertise (based upon competency focus). They will also have the ability to refine their search by sorting on additional fields, such as business unit and location.

In some embodiments, the system may automatically calculate a “confidence index” for each potential advisor/learner pair. In some embodiments, the confidence index is displayed when a user manually selects a potential advisory. In some embodiments, the confidence index for each potential advisor administratively selected is displayed to a user along with the search results. In some embodiments, the confidence index is calculated for an advisor-driven search, but the confidence index is calculated for the potential learner rather than the potential advisor.

The confidence index is calculated for search results to order the matches based on the learning specifications involved in an engagement. The confidence index ranking formula may consider competency profiles, demographics, business information, as well as engagement results over time to determine the best matches for a learner search. As can be appreciated, an advisor having a higher confidence index is considered more likely to be capable of meeting the learning objectives identified by the learner, thereby making it more likely that the goals of the engagement will be met.

Regardless of how learners and advisors initially match with one another, once engaged, embodiments of the present invention provide a variety of collaboration tools to assist the pair with managing their relationships. These tools include, but are not limited to:
Messaging—this allows the learners and advisors to exchange asynchronous messages with one another. The messages are captured as threads and will be available to advisors and learners throughout their relationships, as well as in the future, even after their relationships are completed.
Calendaring—this allows pairs to establish one-time and recurring events (e.g., a monthly mentoring meeting). The calendar utility synchs with other calendaring systems.
Journaling—this allows individual users to capture reflections on their relationship (e.g., around progress being made). As opposed to the Messaging feature, Journal entries are only viewable to the individuals who make the entry and not to their engagement partners.
Mentoring Advice—this allows users to submit mentoring-based questions. These questions come to us (Triple Creek), and allows our Client Services staff to provide best practice mentoring advice/recommendations to users.
Relationship Management tools—these consist of a variety of resources to help mentoring pairs further manage their relationships. They include tools focused on things such as issue analysis, decision making, understanding functional differences, and communication styles.
Document Repository and Management—allows pairs to upload, share, and manage versions of documents to assist with their mentoring relationship.
Talk Tools—a feature that helps users of the system to frame dialogues that they would like to have with their mentoring partner. Regardless of the focus of a specific talk tool, the user initiates the talk tool prior to a conversation with their mentoring partner. Through a directed workflow process, the tool prompts the users to define the parameters of the conversation (e.g., why they are having the conversation with their partner, what they already know about that which they will discuss, desired outcomes from the conversation, etc.). Some exemplary talk tool types that may be utilized in accordance with at least some embodiments of the present invention include, developing goals, defining an issue, analyzing a root cause, brainstorming alternatives, making a decision, having a difficult conversation, motivating an individual, motivating a team, handling an objection, holding an individual accountable, and holding a team accountable. Customized talk tools may also be created and utilized in accordance with embodiments of the present invention.

Group Mentoring

Embodiments of the present invention also help learners connect with experts via Group Mentoring events. Group Mentoring, as its name suggests, is where there is one or more advisors who facilitate a learning group for multiple learners. Client administrators can determine whether all groups must be set up by the administrator (with the help of advisors) or if users can also start their own groups, without permission from an administrator. The latter would be more of an “organic” or “grass roots” type of process. Regardless, when groups are started, there are a variety of things that can be done to establish a group, including:
Developing a group charter—the focus of the group
Identifying the competencies that the group will focus on—taken from the organization's competencies
Determining the enrollment permissions for the group, which include:
   Open—anyone can see that it is available and can join
   Restricted—anyone can see that it is available, but they need to apply and approved by an administrator in order to join
   Invitation only—only those invited even know that the group exists
Defining additional group parameters (e.g., how often the group will meet, whether the group will meet in-person, virtually or both)
Inviting and/or assigning advisor(s) to lead the group
Inviting and/or assigning learner(s) to lead the group

Once members (both advisors and learners) are secured, embodiments of the present invention provide the same utilities for the group to use that exists on the one-to-one side (i.e., Messaging, Calendaring, Journal, Mentoring Advice, Relationship Management tools, Document Repository, Management, and Talk Tools).

Situational Mentoring

Situational Mentoring is a process whereby a learner (or advisor) has a more specific, defined learning (or teaching) need, which can often be described as a situation, issue, problem, or opportunity that they need help with addressing. In at least one embodiment, the learner can engage one or more advisors to help them with their situation. When framing up their situation, the user takes a somewhat different approach than they do in the one-to-one mentoring solution. While they do select 1-5 competency areas to help define the situation/issue/problem/opportunity, they are also prompted to provide more information on the situation, including one or more of:
Description of the situation
How the situation has impacted them
What their desired outcome(s) are. What are they looking for as resolution? For example, are they looking to make a decision among alternatives or simply to develop alternatives?
Assumptions they have made about their situation
Things that they have already tried (to address their situation)

After framing up their situation with some or all of the above information, they can search for one or more advisors and invite them in to help them address the situation. The way that they find potential advisors is the same as the One-to-One mentoring, in that they see potential matches based upon competencies and can further filter based on other fields that are important to them. They can also opt to make their issue “open.” In doing so, the issue is viewable to experts (potential advisors) in the system who have not been invited, and they can volunteer their assistance, even if not solicited to do so. Once engaged, the learner and advisor(s) have the same, aforementioned utilities to help them manage their relationship.

Another aspect of the present invention is that something that starts out as a situation could:
1. Transition into a Group Mentoring event. For example, the learner and advisors who are working together think that the situation they are working on is one that is common in the organization and that others could benefit in the learning that is happening. In such an instance, they can change it to a Group Mentoring event by providing some additional definition around the group charter/goals and invite others and/or make it available for people to join.
2. Transition to a One-to-One relationship. For example, the learner may resolve their specific issue, and in the process think that one of the advisors that assisted them could help them with longer term development goals. They could invite that person into a one-to-one relationship to focus on those goals.

Administrative Features

In addition to the user experience (defined by One-to-One, Group, and Situational), there are administrative features available to client champions who are running programs, including:
Reporting—standard, templated reports and custom report builder
Prospecting tool—integrated email campaign tool used to promote the program and invite people directly into the system (through hyperlink directly to login included in the campaign messages)
Survey tool—provides ability to create, distribute, and automatically tabulate results of surveys to learners and advisors
User management tools—provides the ability for the administrators to manage multiple programs and users. Allows them to connect sub-populations to one another so that they can segment populations of advisors and learners, if necessary (e.g., only high potential learners have access to C-level advisors). Also allows administrators to manage individual user accounts (e.g., edit user's account, delete user).
Third-Party/Administrator Match—allows administrators to match learners and advisors (for those clients who want to control matches). This is optional functionality and does not need to be used.

Additional aspects of the present invention include, but are not limited to the following features:
Increased savings over hand-matched programs
Reduced administrative burdens
Reporting, recruiting and surveying functionality
Full administrative support
Complete end user assistance
One-on-one, group, and situational mentoring functionality
Automated self-selection and third-party matching
Configurable content
Learner-driven agreements focused on their learning goals
Open networks for finding help
Clear method for learners and advisors to follow
Talk Tools to stimulate mentoring dialogue
Confidence Index for search results comparison and ranking

In accordance with at least some embodiments of the present invention, a method is provided that generally comprises:

The term “computer-readable medium” as used herein refers to any tangible storage and/or transmission medium that participates in providing instructions to a processor for execution. As an alternative to executable instructions, the contents may include data to be processed, such as query parameters. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the present invention are stored.

The terms “determine,” “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

FIG. 1 depicts a communication system in accordance with at least some embodiments of the present invention;

FIG. 2 depicts an application diagram in accordance with at least some embodiments of the present invention;

FIG. 3 depicts a system architecture diagram in accordance with at least some embodiments of the present invention; and

FIG. 4 depicts an exemplary work flow diagram in accordance with at least some embodiments of the present invention.

### DETAILED DESCRIPTION

The invention will be illustrated below in conjunction with an exemplary communication system. Although well suited for use with, e.g., a system using a server(s) and/or database(s), the invention is not limited to use with any particular type of communication system or configuration of system elements. Those skilled in the art will recognize that the disclosed techniques may be used in any communication application in which it is desirable to enhance mentoring relationships.

The exemplary systems and methods of this invention will also be described in relation to communications software, modules, and associated communication hardware. However, to avoid unnecessarily obscuring the present invention, the following description omits well-known structures, network components and devices that may be shown in block diagram form, are well known, or are otherwise summarized.

For purposes of explanation, numerous details are set forth in order to provide a thorough understanding of the present invention. It should be appreciated, however, that the present invention may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communication network and/or the Internet, or within a dedicated secure, unsecured and/or encrypted system. Thus, it should be appreciated that the components of the system can be combined into one or more devices, such as an enterprise server or collocated on a particular node of a distributed network, such as an analog and/or digital communication network. As will be appreciated from the following description, and for reasons of computational efficiency, the components of the system can be arranged at any location within a distributed network without affecting the operation of the system. For example, the various components can be located in a local server, at one or more users' premises, or some combination thereof.

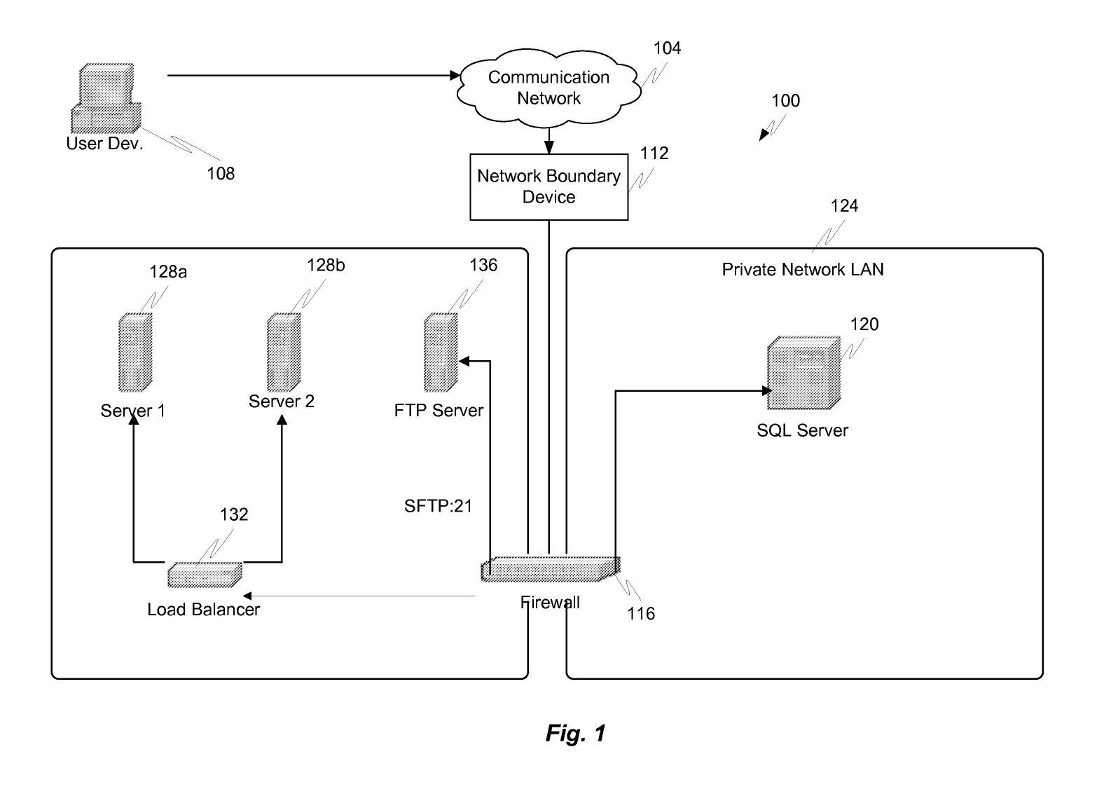

Referring now to FIG. 1, an exemplary communication system 100 will be described in accordance with at least some embodiments of the present invention. The communication system 100 may comprise a communication network 104 that facilitates communications between one or more communication devices, such as a user device 108 and a hosted web service. Alternatively, or in addition, an enterprise server may be connected to the communication network 104 and may also be accessible by certain user devices 108.

The communication network 104 may be any type of known communication medium or collection of communication mediums and may use any type of protocols to transport messages between endpoints. The communication network 104 may include wired and/or wireless communication technologies. The Internet is an example of the communication network 104 that constitutes and IP network consisting of many computers and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), an enterprise network, and any other type of packet-switched or circuit-switched network known in the art. In addition, it can be appreciated that the communication network 104 need not be limited to any one network type, and instead may be comprised of a number of different networks and/or network types.

The user device 108 may be any type of known communication or processing device such as a personal computer, laptop, Personal Digital Assistant (PDA), cellular phone, smart phone, telephone, contact center resource, DCP phone, analog phone, or combinations thereof. The user devices 108 may be controlled by or associated with a single user or may be adapted for use by many users (e.g., an enterprise communication device that allows any enterprise user to utilize the communication device upon presentation of a valid user name and password). In general, each user device 108 may be adapted to support video, audio, text, and/or data communications with other user devices 108. The type of medium used by the user device 108 to communicate with other communication devices may depend upon the communication applications available on the user device 108.

In accordance with at least some embodiments of the present invention, the user device 108 may comprise a browser application that enables the user device 108 to interface with a remote module provided by the web service or enterprise server. In some embodiments, the user device 108 accesses a server (e.g., web server 128a, 128b and/or File Transport Protocol (FTP) server 136) located within a secure domain. In some embodiments, the servers 128a, 128b, 136 may reside behind a network boundary device 112 and/or firewall 116. The network boundary device 112 may correspond to one or more gateways, routers, Session Border Controllers (SBCs) or the like. The firewall 116 may comprise one or more rule sets for controlling data passing between the servers 128a, 128b, 136 and user device 108. In particular, the firewall 116 may be configured to restrict or deny access to certain types of user devices 108 or packets transmitted from user devices 108 containing certain content (e.g., spam, viruses, malware, etc.).

In accordance with at least some embodiments of the present invention, the functionality of the firewall 116 may be incorporated into the network boundary device 112.

The server(s) 128a, 128b, 136 may comprise a set of instructions stored as application instructions on a computer readable medium. The instructions may include one or more modules for facilitating a learner/advisor engagement as will be described in further detail herein. In some embodiments, multiple servers 128a, 128b are provided and accessed via a load balancer 132 to ensure high availability to the user device 108 as well as to ensure redundancy in case of a server failure.

Although only two servers 128a, 128b are depicted in FIG. 1, one skilled in the art will appreciate that a greater or lesser number of servers may be provided without departing from the scope of the present invention. Moreover, the FTP server 136 may be provided as another source of data redundancy, or it may be provided to offer different features not offered by the servers 128a, 128b. The organization of services offered by the various servers in the secured network may vary as can be appreciated by those skilled in the art.

Each of the servers 128a, 128b, 136 may also be configured to perform database lookups at a Service Query Lookup (SQL) server 120. Although the SQL server 120, a particular type of database server, is depicted in FIG. 1, those skilled in the art will appreciate that other types of database devices may be provided. For example, while the SQL server 120 may be enabled to provide relational database models, other types of data organization and models may be used.

The SQL server 120 may be provided behind the firewall 116 to protect the data stored thereon from potential malicious attacks and other threats commonly associated with unsecured data storage. By virtue of the fact that the SQL server 120 is located behind the firewall 116, the SQL server 120 may be considered to reside within a private Local Area Network (LAN) 124. In some embodiments, the LAN 124 may correspond to the same LAN on which the servers 128a, 128b, and/or 136 reside. In some embodiments, the servers 128a, 128b, and/or 136 may reside on a first LAN whereas the SQL server 120 may reside in a different LAN 124 separated from the first LAN by the firewall 116 and potentially the communication network 104. For example, a mentoring service provider may host the servers 128a, 128b, 136 and a customer of the mentoring service provider may retain control over the SQL server 120 and the data stored thereon. Since the SQL server 120 and other servers 128a, 128b, 136 may be operated by different entities, the firewall 116 becomes necessary to secure both LANs from potential attacks.

The SQL server 120 is a computer application used to create desktop, enterprise, and web-based database systems for facilitating the mentoring services discussed herein, such as a mentor module. It is used at different levels and with various goals. In some embodiments, the SQL server 120 may also host other services and store data for other purposes. For example, the SQL server 120 may comprise general enterprise data (e.g., employee information, client information, and other data used by an enterprise).

The user device 108 may access the services of the servers 128a, 128b, 136, 120 via any type of known communication protocol or combinations of communication protocols. Furthermore, the services provided thereon may be written in any type of programming language and may be accessed by the browser of the user device 108 using any type of compatible protocol (e.g., HTML, XHTML, XML, AJAX, etc.). Thus, the mentoring module may be utilized as a shared application environment with each user's experience depending upon that user's enrollment and usage preferences (or the preferences of its overall organization).

In accordance with at least some embodiments of the present invention, a connection may be established between a web server 128a and the SQL server 120. This connection may allow the web server 128a to send updates for the mentor module to the SQL server 120 without disrupting the operation of the mentor module. As one example, a Virtual Private Network (VPN) connection may be established through the communication network 104 and firewall 116 between the web server 128a and the SQL server 120 whereby the web server 128a is allowed to send software updates to the SQL server 120.

In accordance with at least some embodiments of the present invention, the user device 108 may be located within the same enterprise as the SQL server 120 and by virtue of belonging to the same enterprise may be allowed to access certain features of the mentor module not available to other non-enterprise users. Alternatively, or in addition, access to the features of the mentor module (residing on either the web server 128a or enterprise server 120) may be based on user accounts. More specifically, a user may be required to create an account such that a separate instance of data for the account can be maintained in the database hosted by the SQL server 120. Accounts may be set up on a user basis or on a client basis (i.e., a corporate client that has multiple users). Once an account has been established for the client and/or user, the mentor module is adapted to retrieve the appropriate data for that client and/or user from the SQL server 120 and facilitate the creation and growth of advising relationships between that user and other users.

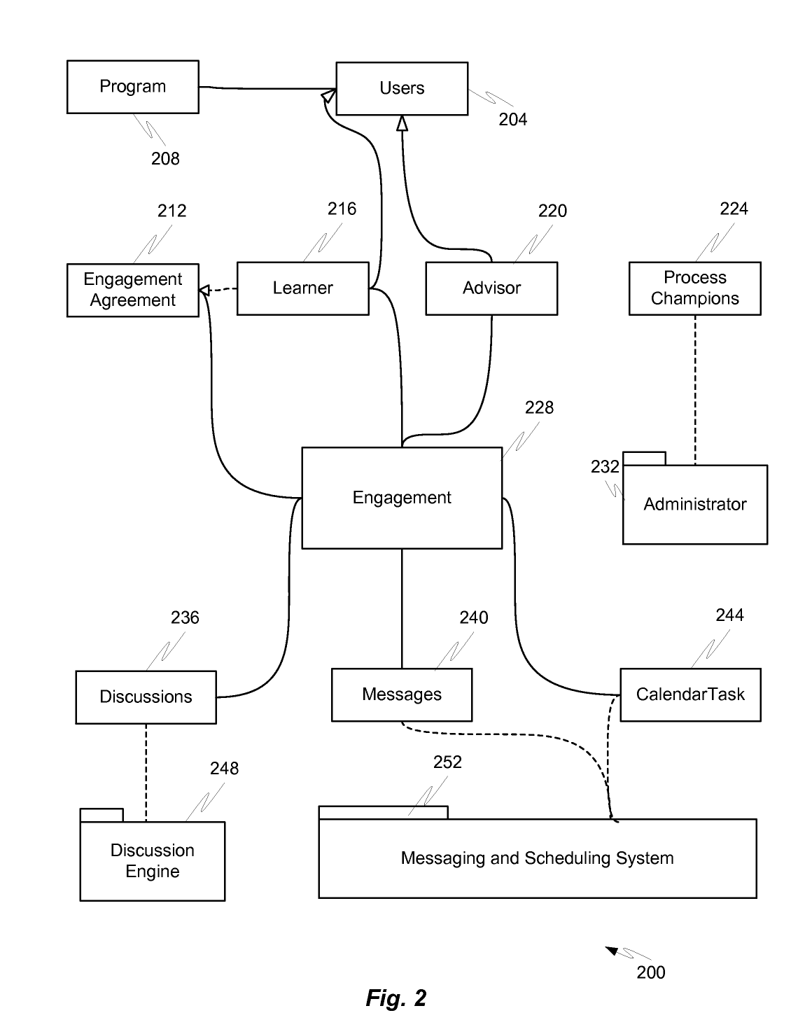

With reference now to FIG. 2, additional details of the types of applications and services which may be provided to the user device 108 via the components depicted in FIG. 1 will be described. As can be seen a number of different applications which generally constitute the mentor module described herein may be hosted on the servers 128a, 128b, 136, and/or 120. In particular, a set of applications 200 may include, without limitation, a number of user applications 204, program applications 208, engagement agreements 212, learner applications 216, advisor applications 220, process champion applications 224, engagements 228, administrator files 232, discussion threads 236, messages 240, calendar tasks 244, discussion engine files 248, and messaging and scheduling system files 252.

The user applications 204 may comprise rules for creating a user within a mentoring module. The user applications 204 may control the data types and data structures associated with users of the mentoring module. The format of the user applications 208 may also be customizable on a per-client basis, meaning that each client that purchases and uses the mentoring module may program rules within their own program 208 to control the specific types of data included in the user applications 204. This may allow a highly customized mentoring solution for multiple different customers, which can be help customers of different needs achieve their mentoring goals.

The engagement agreements 212 may include rules for conducting engagements 228 between users (i.e., learners 216 and advisors 220). In particular, the engagement agreements 212 may comprise data for controlling the structure of engagements 228, which again may be customized on a per-client basis. In some embodiments, the engagement agreements 212 may also comprise data defining the goals of engagements 228 and the process defined for the learner 216 and advisor 220 to interact and meet such goals during the engagements 228.

In some embodiments, a plurality of engagements may exist within the engagements 228 at any given time. In some embodiments, each engagement between a learner 216 and advisor 220 is set to last for a particular amount of time, meaning that the learner 216 and advisor 220 will interact during their engagement until a particular goal or set of goals is met. Once met, the learner 216 and advisor 220 may not be required to interact for that particular engagement, but the data structure of the now completed engagement may be maintained in the engagements 228 for future use and possible data harvesting. In some embodiments, the data from the engagements 228 may be analyzed, either periodically or continuously to determine whether an enterprise has any knowledge gaps (e.g., gaps in knowledge between users 204, a lack of advisors 220 in a particular field, no users 204 with a particular knowledge, a lack of engagements 228 in a particular field, and the like). This information can be utilized by the enterprise utilizing the mentoring module to determine what other types of steps can be taken to ensure that knowledge is properly disseminated throughout their organization.

The rules surrounding the interactions during an engagement 228 may be defined within one or more of the process champions applications 224, program applications 208, user applications 204, and the like. The actual interactions which occur during an engagement 228 may be facilitated by a discussion engine 248 and/or messaging and scheduling system 252. In some embodiments, the discussion engine 248 may comprise any type of known discussion system or collection of discussion systems. For example, collaboration tools, semi-private blogs, whiteboard applications, and the like may be provided by the discussion engine 248 to facilitate discussions 236 between users during an engagement 228.

The messaging and scheduling system 252 may correspond to any type of known messaging and scheduling system, such as Microsoft Outlook, which is capable of providing email messaging capabilities and calendaring capabilities. The messaging and securing system 252 may facilitate the creation and sharing of messages between users during an engagement 228 as well as the coordination of user schedules. During such a coordination, the goals of the engagement 228 may be considered by the messaging and scheduling system 252 to identify common times during which a learner 216 and advisor 220 can meet. These common times can be utilized to automatically schedule calendar tasks 244 within both of the user's calendars, thereby facilitating easy live interactions between users. Other types of calendar tasks 244 which may be utilized include, without limitation, meeting times, task reminders, to-do lists, and the like. All of the calendar tasks 244 may be utilized to ensure that the engagements 228 are progressing toward one or more goals of the engagement 228.

The general rules defining the interactions between the applications and components of FIG. 2 may be controlled by the process champion applications 224. In particular, the process champion applications 224 may be administered by an administrator file or set of files 232 which contain rules defining whether certain users 204 can have certain roles of learners 216 or advisors 220, how and when engagements 228 can be established between users 204, and the ways in which engagements are facilitated (e.g., what types of communications are permitted or required for certain types of engagements 228). The process champions application 224 may also be responsible for harvesting data related to the engagements 228, learners 216, advisors 220, users 204, and the like from time to time to determine if any knowledge gaps exist within the organization utilizing the engagements 228. Rules defining how and when such data gathering occurs may be defined within the administrator files 232 and the data obtained during such data harvesting may be utilized to alter the rules defining how engagements occur 228 and the like.

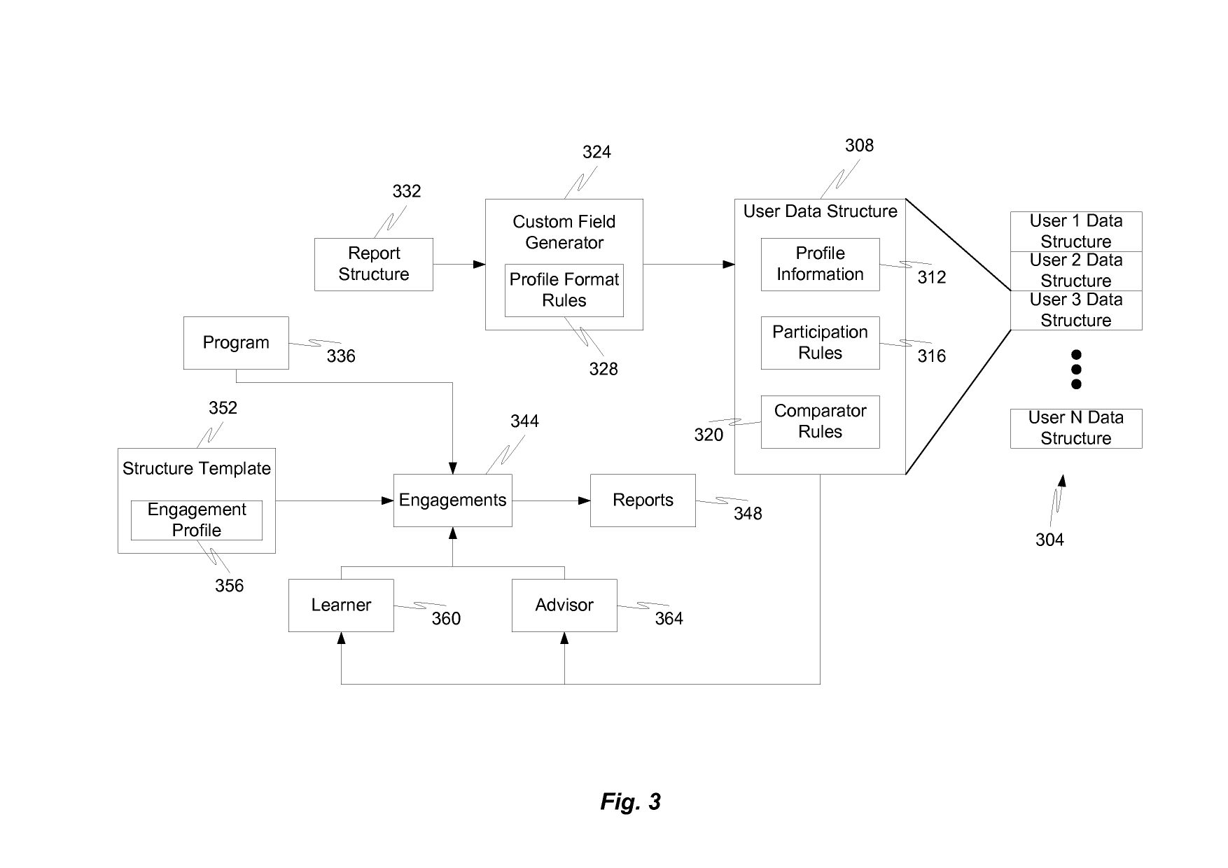

With reference now to FIG. 3, additional details of a system architecture which may be utilized to facilitate engagements will be described. The architecture may include a plurality of user data structures 304, where each data structure may be owned and used for a particular user. In some embodiments, such as where a user has the ability to become or is already both a learner and advisor, a single user may have multiple data structures. Alternatively, all data for a particular user within the mentoring module may be contained within a single user data structure 308.

The details of an exemplary user data structure 308 are depicted as containing profile information 312, participation rules 316, and comparator rules 320. Some or all of the data contained within a user data structure 308 may be owned by the user, meaning that the user has complete control over the format and content of their data structure 308. In some embodiments, however, at least partial control over the user data structures 304 is maintained by the enterprise hosting the SQL server 120. The enterprise may define the requirements needed to participate as a learner or advisor, the types of data that may be included in a user's data structure (i.e., what types of data are pertinent to the engagements and how should such data be organized, etc.), the way in which the data structure 304 is organized, and so on.

The profile information 312 may contain profile information for the user. Examples of profile information which may be contained in the profile information field 312 include, without limitation, name, job title, skill descriptions, competencies, specific areas of expertise, specific needs/desires of expertise, years experience (per skill type or in general), direct supervisors, direct reports (i.e., people that are managed by the user), advising goals, learning goals, and the like.

The participation rules 316 may define whether and to what extent the user desires to participate in engagements. In some embodiments, the content of the participation rules 316 may be user-programmable (i.e., a user may define whether they want to have a learner role, an advisor role, or both and in what skill types such roles are desired). In some embodiments, the content of the participation rules 316, or portions thereof, may be defined by the process champion applications 224. Thus, the organization with which the user is associated may prescribe the types of roles a user may take on and, in certain situations, require a user to take on certain roles.

The comparator rules 320 may comprise a set of fuzzy logic rules which enables the user data structure 308 to be associated with either a learner 360 or advisor 364 data structure for a particular skill type. In some embodiments, the comparator rules 320 may analyze a user's skill sets, expertise, advising history, learning history, and the like to determine whether the user should be engaged in an engagement 344 as either a learner 360 or advisor 364. The comparator rules 320 are especially useful when other users are searching for engagements (e.g., a potential learner is searching for potential advisors) and is defining desirable characteristics of an engagement 344. Based on a user's creation of a desired engagement 344, the comparator rules 320 may be referenced to determine if a particular user is a well-suited candidate for the desired engagement 344. The comparator rules 320 may be analyzed to determine whether the user associated with the user data structure 308 is a good engagement match for the other user creating the desired engagement 344. The comparator rules 320 may also be used to define how well a particular user matches as an engagement match (e.g., if and to what extent the user has profile information that meets the criteria of the desired engagement 344).

Based on existing engagements 344 or desired engagements 344, a user's data structure 308 is associated with one or more of a learner 360 or advisor 364 and if that user is selected to interact in an engagement 344 that information may also be updated in the user's profile information 312.

As can be appreciated by one skilled in the art, a company offering mentoring solutions may wish to provide a ubiquitous solution for customizing engagements on a per-client basis. In particular, each organization and potential client may have different mentoring needs and may need to establish different engagements to facilitate such needs. Thus, a custom field generator 324 is provided which enables the customization of the user data structures 308 on a per-client basis. This means that one client may have user data structures 308 organized in a first way whereas another client may have user data structures 308 organized in a second way. Moreover, the data in the data structures of each client may vary, but the general rules for creating engagements 344 can be duplicated.

In some embodiments, the custom field generator 324 comprises profile format rules 328 which define how data within a user data structure 308 can be organized and the types of information that may be maintained therein. The operation of the custom field generator 324 may also be controlled by a report structure 332 which defines the types of reports 348 that may be desired of existing engagements 344 and the way in which user data structures 308 should be organized to ensure that the engagements 344 are properly formatted and created.

Furthermore, structure templates 352 may be provided along with an engagement profile 356 which generally defined the boundaries and ways in which engagements 344 can be created. For example, the structure template 352 may define certain minimum criteria needed for an engagement 344 (e.g., at least one learner 360, at least one advisor 364, at least one engagement topic, at least one goal, etc.). The structure template 352 may further define the types of data that can be incorporated into an engagement 344 and the way in which an engagement is allowed to be conducted. In particular, the engagement profile 356 may define the workflow (e.g., interaction requirements like weekly meeting, monthly status checks, daily communications, types of communications to be used, etc.) for a particular engagement 344 or may generically define work flows for any engagement by defining certain minimum criteria for the engagement work flows.

Additionally, a program 336 may be provided which enables the engagements 344 to be monitored and controlled by the organization with which the users are associated. The program 336 may also define the hierarchical structure of the organization and the way in which engagements should be created for that organization. For example, the program 336 may define that only certain types of users should be allowed to utilize engagements 344 and it may further define when such users are allowed to do so.

The data structure of the engagements 344 may be persistent, even though an engagement between users is temporal. Thus, the engagements 344 may be harvested from time to time to generate reports 348 which can be utilized to check the status of the engagements 344, whether knowledge is being properly disseminated throughout the organization, whether engagements 344 in certain areas of knowledge are being utilized effectively, whether a knowledge gap exists, and the like. The reports 348 can then be utilized to adjust the profile format rules 328, the engagement profile 356, or provide high-level or detailed feedback to the organization as to whether knowledge is being properly shared within the organization.

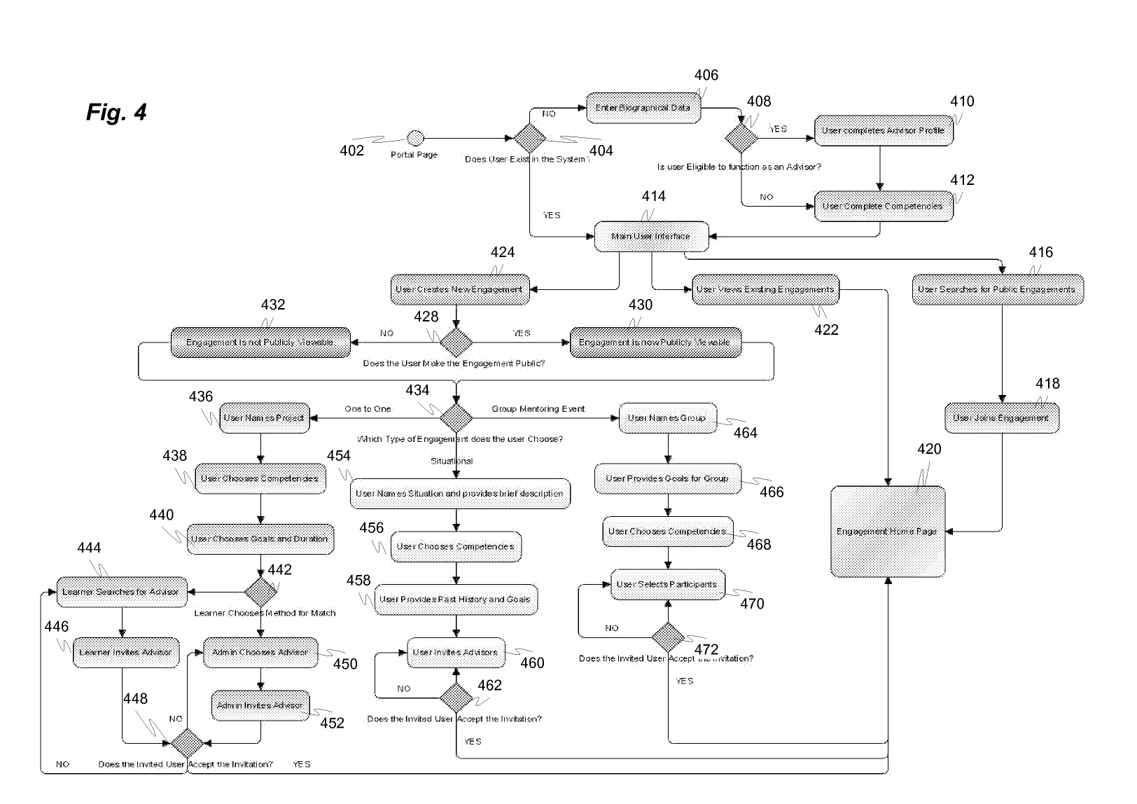

With reference now to FIG. 4, an exemplary work flow of creating and establishing engagements 344 will be described in accordance with at least some embodiments of the present invention. The process begins when a user accesses a portal page, which allows the user's user device 108 access to the content provided by the web servers 128a, 128b (step 402). Such access may be controlled by a user authentication process which may involve confirming that the user has knowledge of a valid user name and password.

Once a user accesses the portal page (e.g., via completing the authentication process), the process continues with the system determining whether the user exists within the system (i.e., whether the user has a user data structure 308 already created for him/her) (step 404). If the user already has a user data structure 308 created, then the method proceeds by providing the user with the main user interface (step 414). Otherwise, the user is required to enter biographical data (step 406) and other personal information for inclusion in the user's profile information 312. Based on the user's identity, a database lookup to an enterprise database may also be performed in this step such that a user's employment title, work history, direct supervisors, direct reports, and the like can be automatically obtained.

Based on the entry of the user's biographical data, the process continues by determining whether the user is eligible to function as an advisor (step 408). If so, then the user first fills out additional information to complete their advisor profile (step 410). Thereafter, or if the query of step 408 is answered negatively, then the method proceeds with the user filling out additional information to define their competencies which will be used to populate the user's profile information 312 (step 412). As can be appreciated by those skilled in the art, both a user's advisor and learner profile information as well as general bibliographic information may be contained within the user's profile information 312 in a combined manner. In some embodiments, however, such data may be segregated within the profile information 312 to facilitate easy modifications and utilizations thereof.

Once the user has entered the necessary information to establish a user data structure 308, the user proceeds to the user interface (step 414). Once at the main user interface, the user is allowed to do a number of different tasks. These tasks may be performed serially or in parallel. One such task may involve allowing the user to search for currently available and public engagements (step 416). Public engagements are those engagements which have been made available for viewing to either all users or a subset of users. A user may be allowed to search publicly available engagements at any time, but it is most likely useful when the user knows of a particular engagement that they want to join and search specifically for that engagement. If the user finds an engagement that they want to join, then the user is allowed to join the engagement (step 418) and is subsequently taken to that engagement's home page (step 420).

As can be appreciate by one skilled in the art, a user may be allowed to participate in multiple engagements at the same time. Thus, a user may be allowed to view multiple engagements at their home page, although certain engagement rules may define that a user is allowed to view only one of their engagements at a time. In particular, a user may be allowed to view an engagement that they just joined and/or other existing engagements in which the user is already participating (step 422).

The engagement home page may comprise one or more communication modalities which enables the user to communicate with other users also participating in the same engagement. For example, an engagement calendar and messaging service may be provided on the engagement home page and other engagement reminders may be displayed for all participants to view.

Referring back to step 414, a user may also be allowed to create new engagements, provided that they have such permissions as allowed by the program 336 and/or structure template 352 (step 424). If the user elects to create a new engagement, then the method proceeds by determining whether the user wants to make the new engagement public (step 428). If so, then the engagement is made publicly available (step 430) and if not the engagement is not made publicly available (step 432). The mechanisms for making engagements publicly available may vary and are well known in the art. For example, password protection of the engagement may be utilized. Alternatively, or in addition, the simple act of viewing the existence of the engagement may not be provided to general users, but may only be available to an administrator.

After the public nature of the engagement has been defined, the method continues by determining the type of engagement which will be created (step 434). Exemplary types of engagements include, without limitation, a one-to-one engagement, a situational engagement, and a group mentoring engagement. If the one-to-one engagement is selected (either by the user or by rules defined by the engagement profile 356), the process continues with the user naming the project (step 436), selecting their competencies to share and/or desired new competencies to be obtained during the engagement (step 438), and choosing one or more goals to be achieved during the engagement (step 440).

Thereafter, the user selects the methods for identifying potential engagement partners (step 442). If the user desires, the user may manually search for an engagement partner (e.g., advisor or learner) (step 444) and invite that potential partner directly (step 446). This invitation may be sent electronically or the user may be provided with the potential partner's contact information for inviting the potential user outside of the mentoring module (step 446). At that point the process waits until the invited user accepts the invitation (step 448). As can be appreciated, multiple potential partners may be invited to participate in a one-to-one engagement in which case rules may be defined which dictate which potential partner becomes involved in the engagement. In some embodiments, a one-to-one engagement may transform into a group mentoring engagement if multiple potential partners are invited during the creation of a one-to-one engagement and two or more of those potential partners accept the invitation.

Referring back to step 442, if the user chooses to have the potential partner selected administratively, then the method proceeds with the administrator selecting the partner for the one-to-one engagement (step 450). This selection may occur by the administrator manually picking the potential partner or by utilizing the comparator rules 320 to determine an optimal potential partner. The selected potential partner is then invited (step 452) and the process waits for the invited user to accept the invitation.

When establishing a one-to-one engagement, the creator of the engagement will answer/define at least some of the following before inviting/assigning advisors and/or learners to the engagement:
Competencies—to help define the learning focus of the engagement.

Competencies are configured to the client's competency set(s). Competencies may be selected via check box functionality (i.e., select all that apply)
Further Clarification of Learning Needs (optional open text)
Goal Statements—users complete the following sentence fragments:
   I will have a complete understanding of ______
   I will be able to ______

Referring back to step 434, if a situational engagement is to be created, then the process continues with the user naming the situation and providing a brief description of the same (step 454), the user choosing one or more competencies to be involved in the engagement (step 456), and the user providing past history and goals for the engagement or past engagements (step 458). Situational engagements are most commonly used for achieving a certain objective, such as a project goal or for having a certain question answered. By defining the competencies to be involved in the situational engagement, the mentoring module may be enabled to automatically select one or many possible partners for the engagement (step 460). Alternatively, or in addition, the user may invite advisors for the situational engagement. The identified potential partners are then invited and the process waits until one or more of the invited participants accept the invitation (step 462).

When establishing a situational engagement, the creator of the engagement will answer/define the following before inviting/assigning advisors and/or learners to the engagement:
What is the situation you want to discuss? (open text)
Give an example of how your situation/problem has impacted you (open text)
How would you like to connect with those who assist you? (single selection)
   I only want to connect with those that I invite
   I want to invite and open my situation to those who can volunteer their assistance
Identify your desired outcomes (select all that apply)
   Clarify the issue
   Clarify values and motives
   Determine options
   Reach a final decision
   Describe other desired outcomes (followed by open text)
Competencies—to help define the learning focus of the engagement. Competencies are configured to the client's competency set(s). Competencies are selected via check box functionality (select all that apply)
List any assumptions (What assumptions are you making about yourself, others, or the outcomes).
Provide any actions already taken (What have you tried so far to understand or address the issues)
Provide any alternatives (Detail all the possible actions you could take to resolve the issue)

Referring back to step 434, if a group mentoring engagement is selected, then the user names the group (step 464), provides goals for the group mentoring engagement (step 466), and chooses one or more competencies to be involved in the engagement (step 468). By defining the goals for the group mentoring engagement, the mentoring module may be enabled to automatically identify one or many possible partners for the engagement (step 470). Alternatively, or in addition, the user creating the engagement may invite participants to the group mentoring engagement. The identified potential partners are then invited and the process waits until one or more of the invited participants accept the invitation (step 472), at which point the engagement data structure is created.

When establishing a group engagement, the creator of the engagement will answer/define at least some of the following before inviting/assigning advisors and/or learners to the engagement:
Group Name
Group goals and objectives
Criteria for participation
Enrollment type (single selection)
   Invitation only
   Open to all (join automatically)
   Restricted (Must request to join)
Enrollment period (single selection)
   Users may join at any time
   Users may only join in a set period
Enrollment start date
Enrollment end date (if selected “Users may only join in a set period”)
Maximum number of group members
Meeting type
   Physical
   Virtual
Physical Location (if physical meeting)
Virtual Location URL (for web meeting info)
Call-in number(s) and code(s)
Competencies—to help define the learning focus of the engagement. Competencies are configured to the client's competency set(s). Competencies are selected via check box functionality (select all that apply)

Group engagements may be created intentionally or by having a one-to-one or situational engagement dynamically transform into a group mentoring event. Likewise, a group engagement may dynamically change to a one-to-one or situational engagement. During such a transformation, the engagement data structure 344 may be copied into a new engagement data structure 344 and pertinent components of the previous engagement can be utilized to create the new engagement data structure 344. Alternatively, the single engagement data structure 344 may be transformed without duplicating the engagement data structure 344. The types of data which may be maintained or copied during the transformation of an engagement includes one or more of goals, competencies, participants, and the like.

After the new engagement has been created at one or more of steps 448, 462, and 472, the method proceeds to step 420 where the user is directed to the engagement home page and allowed to utilize one or more of the engagement tools as described herein.

While the above-discussed flowchart and various other tools have been discussed and are depicted in relation to a particular sequence of events, it should be appreciated that changes to this sequence can occur without materially effecting the operation of the invention. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and communication arts.

Moreover, the disclosed modules may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided, in accordance with the present invention, systems, apparatuses and methods for facilitating meaningful mentoring relationships. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

What is claimed is:

1. A method, comprising:
receiving, at a server connected to a communication network, a first set of user preferences associated with a first user;
determining that the first set of user preferences indicate a desire to establish a mentoring relationship with a second; and
providing to the first user a list of options for create a mentoring engagement with the second user, the list of options including two or more of a one-to-one mentoring relationship, a situational mentoring relationship, and a group mentoring relationship.

2. The method of claim 1, wherein the second user is at least one of manually selected by the first user and administratively selected by a set of selection rules.

3. The method of claim 1, further comprising:
determining a match confidence index for the second user, wherein the confidence index is determined based on one or more of the following parameters: (i) the number of preferences in the first set of user preferences that match user attributes for the potential mentoring relationship partner; (ii) a number of keyword occurrences from the first set of user preferences that are found in user preferences for the potential mentoring relationship partner; (iii) a number of similar keyword occurrences from the first set of user preferences that are found in the user preferences for the potential mentoring relationship partner; (iv) a similarity of the user-defined situation with the set of user attributes for the potential mentoring relationship partner; (v) competency profiles of the first user; (vi) competency profiles of the second user; (vii) relative demographics of the first and second user; and (viii) historical engagement results.

4. The method of claim 3, wherein at least parameter (iv) is used and wherein the user-defined situation comprises at least a string of characters entered by the first user, and wherein the string of characters comprise at least one keyword that is related to an attribute in the set of user attributes for the potential mentoring relationship partner.

5. The method of claim 4, wherein the set of user attributes for the potential mentoring relationship partner includes one or more competencies selected by the potential mentoring relationship partner and wherein the at least one keyword matches or substantially matches the one or more competencies.

6. The method of claim 1, further comprising:
receiving a selection from the first user of a mentoring relationship desired from the list; and
attempting to establish the selected type of mentoring relationship between the first user and the second user.

7. The method of claim 6, wherein a group mentoring relationship is selected and wherein the first user provided at least one of the following parameters as inputs for creating the group mentoring relationship: group name, group goals, criteria for participation, enrollment type, enrollment period, maximum number of group members, meeting type, and competencies.

8. The method of claim 6, wherein a situational mentoring relationship is selected and wherein the first user provided at least one of the following parameters as inputs for creating the situational mentoring relationship: situation for discussion, desired outcomes, competencies, assumptions, actions already taken, alternative actions not yet taken.

9. The method of claim 6, wherein a one-to-one mentoring relationship is selected and wherein the first user provided at least one of the following parameters as inputs for creating the one-to-one mentoring relationship: competencies, learning needs, and goal statements.

10. The method of claim 6, further comprising:
establishing the selected type of mentoring relationship between the first user and the second user; and
after the established mentoring relationship has been established, transforming the mentoring relationship from a first type of mentoring relationship to a second type of mentoring relationship.

11. A method, comprising:
receiving, at a server connected to a communication network, a first set of user preferences associated with a first user;
determining, by the server, that the first set of user preferences indicate a desire to establish a mentoring relationship with a second user in connection with a user-defined situation or problem;
receiving, at the server, an identification of the second user; and
establishing, by the server, a situational mentoring relationship between the first and second user.

12. The method of claim 11, wherein the second user was included in an administratively-generated list of potential mentoring partners based on input received from the first user, and wherein the second user was selected by the first user from the list of potential mentoring partners.

13. The method of claim 12, wherein the input received from the first user which resulted in the creation of the administratively-generated list included one or more of the following input parameters: an identification of a situation to be discussed, an example of a situation impact, an identification of desired outcomes, an assumption made by the first user, actions taken by the first user prior to the establishing step, and possible alternatives for addressing the situation.

14. The method of claim 11, wherein the identification of the second user was typed in by the first user.

15. The method of claim 11, wherein the situational mentoring relationship comprises a closed mentoring relationship that is not viewable by other users.

16. A method, comprising:
receiving, at a server connected to a communication network, a first set of user preferences associated with a first user;
determining, by the server, that the first set of user preferences indicate a desire to establish a mentoring relationship with a second user;
establishing a mentoring relationship between the first user and at least the second user; and
providing one or both of the first and second user with talk tools for use in connection with the mentoring relationship, wherein the talk tools frame dialogues between the first and second users by prompting one or both of the users to define parameters of the conversation.

17. The method of claim 16, wherein the talk tools enable the first and second users to at least one of develop goals, define an issue, analyze a root cause, brainstorm alternatives, make a decision, motivate an individual, handle an objection, hold an individual accountable, and hold a team accountable and wherein the prompts provided to one or both of the users vary depending upon the type of talk tool being utilized.

18. The method of claim 16, wherein the mentoring relationship comprises one of a one-to-one mentoring relationship, a situational mentoring relationship, and a group mentoring relationship.

19. The method of claim 16, wherein the prompts are provided to one or both of the user during a conversation between the users.

20. The method of claim 16, wherein a first set of prompts are provided to the first user and a second set of prompts are provided to the second user and wherein the first and second sets of prompts are different.
